(19) United States
(12) Patent Application Publication
(10) Pub. No.: US 2007/0156736 A1
(43) Pub. Date: Jul. 5, 2007

(54) Method and apparatus for automatically detecting a latent referential integrity relationship between different tables of a database

(75) Inventors: Robert Joseph Bestgen, Dodge Center, MN (US); Shantan Kethireddy, Rochester, MN (US); Michael Donald Pfeifer, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/326,564

(22) Filed: Jan. 5, 2006

(51) Int. Cl. G06F 7/00

(52) U.S. Cl. 707/101

(57) ABSTRACT

In one aspect, a database analytical tool or function analyzes join queries to detect queries which could be reduced if a referential integrity relationship were known. In another aspect, a probable latent referential integrity relationship is detected using one or more heuristics. Preferably, a join query is analyzed to detect a joined table which has no other conditions placed on it, and no referential integrity relationship already defined. For any such query, the analysis attempts to verify a probable latent referential integrity relationship using at least one heuristic, such as comparing cardinality of the potential primary key with the size of the table and/or with the cardinality of the foreign key. It is further possible to execute the join for some sample of records, and determine whether any records were found which did not conform to referential integrity constraints.

### FIELD OF THE INVENTION

The present invention relates generally to digital data processing, and more particularly to the operation and maintenance of structured databases in a digital computer system.

### BACKGROUND OF THE INVENTION

In the latter half of the twentieth century, there began a phenomenon known as the information revolution. While the information revolution is a historical development broader in scope than any one event or machine, no single device has come to represent the information revolution more than the digital electronic computer. The development of computer systems has surely been a revolution. Each year, computer systems grow faster, store more data, and provide more applications to their users.

A modern computer system typically comprises hardware in the form of one or more central processing units (CPU) for processing instructions, memory for storing instructions and other data, and other supporting hardware necessary to transfer information, communicate with the external world, and so forth. From the standpoint of the computer's hardware, most systems operate in fundamentally the same manner. Processors are capable of performing a limited set of very simple operations, such as arithmetic, logical comparisons, and movement of data from one location to another. But each operation is performed very quickly. Programs which direct a computer to perform massive numbers of these simple operations give the illusion that the computer is doing something sophisticated. What is perceived by the user as a new or improved capability of a computer system is made possible by performing essentially the same set of very simple operations, but doing it much faster. Therefore continuing improvements to computer systems require that these systems be made ever faster.

The overall speed at which a computer system performs day-to-day tasks (also called “throughput”) can be increased by making various improvements to the computer's hardware design, which in one way or another increase the average number of simple operations performed per unit of time. The overall speed of the system can also be increased by making algorithmic improvements to the system design, and particularly, to the design of software executing on the system. Unlike most hardware improvements, many algorithmic improvements to software increase the throughput not by increasing the average number of operations executed per unit time, but by reducing the total number of operations which must be executed to perform a given task.

Complex systems may be used to support a variety of applications, but one common use is the maintenance of large databases, from which information may be obtained. Large databases usually support some form of database query for obtaining information which is extracted from selected database fields and records. Such queries can consume significant system resources, particularly processor resources, and the speed at which queries are performed can have a substantial influence on the overall system throughput.

Conceptually, a database may be viewed as one or more tables of information, each table having a large number of entries (analogous to rows of a table), each entry having multiple respective data fields (analogous to columns of the table). The function of a database query is to find all rows, for which the data in the columns of the row matches some set of parameters defined by the query. A query may be as simple as matching a single column field to a specified value, but is often far more complex, involving multiple field values and logical conditions. A query may also involve multiple tables (referred to as a “join” query), in which the query finds all sets of N rows, one row from each respective one of N tables joined by the query, where the data from the columns of the N rows matches some set of query parameters.

Execution of a query involves retrieving and examining records in the database according to some search strategy. For any given logical query, not all search strategies are equal. Various factors may affect the choice of optimum search strategy and the time or resources required to execute the strategy.

For example, one of the factors affecting query execution is the sequential order in which multiple conditions joined by a logical operator, such as AND or OR, are evaluated. The sequential order of evaluation is significant because the first evaluated condition is evaluated with respect to all the entries in a database table, but a later evaluated condition need only be evaluated with respect to some subset of records which were not eliminated from the determination earlier. Therefore, as a general rule, it is desirable to evaluate those conditions which are most selective (i.e., eliminate the largest number of records from further consideration) first. and to evaluate conditions which are less selective later. Another factor can be the presence of certain auxiliary database structures which may, if appropriately used, provide shortcuts for evaluating a query. One well known type of auxiliary database structure is an index. An index is conceptually a sorting of entries in a database table according to the value of one or more corresponding fields (columns). If a query includes an indexed value as a condition, it may be advantageous to use the index to determine responsive records, rather than examine each record in the applicable table. A well-designed database typically contains a respective index for each field having an ordered value which is likely to be used in queries. Various other factors may affect query execution.

To support database queries, large databases typically include a query engine which executes the queries according to some automatically selected search strategy, using the known characteristics of the database and other factors. Some large database applications further have query optimizers which construct search strategies, and save the query and its corresponding search strategy for reuse. In such systems, it may be possible to construct and save multiple different query execution strategies for a single query, and data enabling selection of an appropriate execution strategy for any particular instance of the query.

Modern query optimizers are capable of performing some sophisticated optimizations, which sometimes include a re-formulation of the logical query itself into a form which will produce the same result set, yet execute more efficiently. On such optimization is reduction of a join query by elimination of a joined table from the logical query based on a known referential integrity constraint.

Referential integrity is a characteristic relationship of certain database tables, which is normally part of the original database design. In database design, it is common to provide a reference in one table to something in another table. A field which references a record in another table is referred to as a “key”. In a common relationship, each record in a first table (or, in some cases, each record of a subset of records in the first table) references a respective unique record in a second table (although it is possible that more than one record in the first table could reference the same record in the second table). The first table contains a key field referred to as a “foreign key” for referencing the corresponding record in a second table. Each record in the second table contains a key field referred to as a “primary key”, each primary key value being unique (occurring only once) in the second table. By matching the foreign key of a record in the first table with the primary key of a record in the second, it is possible to determine which record in the second corresponds to (is referenced by) the record in the first table.

In order for this reference to produce consistent results, the following constraints on the key values are observed: (a) every record of the second table must contain a primary key value which is unique and non-null; and (b) every record in the first table must contain a foreign key value which appears in the primary keys of the second table, or which is null (if the database definition so allows). These constraints are collectively referred to as referential integrity constraints, and the relationship between the key fields is a referential integrity relationship.

Where a database is designed to include tables and key fields having a referential integrity relationship, the original designer will normally specify that relationship as part of the original design. The database management software subsequently enforces the referential integrity constraints by verifying updates to database records for compliance with the constraints, and not performing any attempted update which would violate the constraints.

Often, a join query can be reduced based on a known referential integrity constraint. For example, consider the following simple query:

select A.primarykey

from TABLE_A, TABLE_B

where TABLE_A.primarykey=TABLEB.foreignkey.

If it is known in advance that there is an enforced referential integrity relationship between TABLEA and TABLEB whereby TABLEA.primarykey is a primary key and TABLE_B.foreignkey is a foreign key, then it is also known that every non-null value of TABLE_B.foreignkey appears as a primary key in TABLE_A. The condition simply returns all values of the primary key which correspond to values of the foreign key, in other words, all unique non-null values of the foreign key. The query therefore can be reduced to:

select TABLE_B.foreignkey

from TABLE_B

where TABLE_B.foreignkey not null.

The reduced expression does not join TABLE_A, will not require a search of TABLE_A, and will generally execute using significantly less resource. Although the example above is a relatively simple one for illustrative purposes, it will be understood that a query could be, and often is, considerably more complex, containing multiple joins and conditions. Join queries of this type are becoming increasingly frequent as a result of the use of certain query construction tools, which re-use encapsulated views of a database.

Where the database designer has specified, and the database management software has enforced, a referential integrity constraint, the optimizer can safely reduce a join query of the type exemplified above. However, in many instances there exists a latent referential integrity relationship which is not defined by the designer or enforced by the database management software. I.e., the data in the database may conform to the referential integrity constraints, even though there is no enforcement mechanism for assuring referential integrity. This may occur as a result of oversight when the database was originally defined, or may been a deliberate decision to use some external referential integrity enforcement mechanism instead of that provided by the database management software, or even may have resulted from changes in the character of the database, or for some other reason. In such cases, conventional optimizers are unable to reduce a join query of the type exemplified above because the optimizer does not know that the data conforms to the referential integrity constraints in advance of executing the query.

A need therefore exists, not necessarily recognized, for improved techniques for managing database referential integrity, and particularly for detecting the presence of a latent referential integrity relationship in one or more join queries and using this information to optimize the join queries.

### SUMMARY OF THE INVENTION

In a first aspect of the preferred embodiment of the present invention, a database analytical tool or function analyzes join queries to detect one or more queries which could be reduced if a referential integrity relationship were known.

In a second aspect of the preferred embodiment of the present invention, a database analytical tool or function detects a probable latent referential integrity relationship using one or more heuristics.

In accordance with the preferred embodiment, a database analytical tool or function analyzes a join query to detect a join condition which is not reducible for lack of defined referential integrity, but which could be reduced by removing at least one joined table, if it could be assumed in advance that the joined table was superfluous due to the existence of referential integrity. Specifically, if a table is joined but has no other conditions placed on it, and if no referential integrity relationship is already defined, then the query is a suitable candidate. If such a condition is found in the query, the analysis further attempts to verify a probable latent referential integrity relationship using at least one heuristic. Specifically, it compares the known or projected cardinality of the potential primary key with the size of the table containing the primary key and/or with the known or projected cardinality of the foreign key. Optionally, it would further be possible to execute the join for some sample subset of records, and determine whether any records were found which did not conform to a referential integrity relationship.

In the preferred embodiment, results are presented to the user by alerting the user to any query which could be reduced based on a probable latent referential integrity relationship. The user may elect to explicitly define a referential integrity relationship, thus invoking the referential integrity enforcement mechanisms of the database, or may elect to optimize based on referential integrity, i.e., to force the optimizer to optimize the query (perform the join reduction) on the assumption that referential integrity is present, even though it is not enforced by the database. The user may optionally be provided further data for the user in making a decision, such as projections of cost savings and the like.

By identifying queries capable of reduction based on latent referential integrity, the analytical tool provides valuable information to a database user which may be used to significantly improve performance not only of a current query instance but of numerous future query instances (or even unrelated queries of the same database).

The details of the present invention, both as to its structure and operation, can best be understood in reference to the accompanying drawings, in which like reference numerals refer to like parts, and in which:

### BRIEF DESCRIPTION OF THE DRAWING

FIG. 1 is a high-level block diagram of the major hardware components of a computer system for executing database queries and detecting a latent referential integrity relationship in a database, according to the preferred embodiment of the present invention.

FIG. 2 is a conceptual illustration of the major software components of a computer system for executing database queries and detecting a latent referential integrity relationship in a database, according to the preferred embodiment.

FIG. 3 is a conceptual representation of a simplified database environment in which keys are used to create associations of records in different tables, according to the preferred embodiment.

FIG. 4 is a flow diagram illustrating at a high level the process of executing a database query, according to the preferred embodiment.

FIG. 5 is a flow diagram showing the process of analyzing multiple queries in the plan cache to find one or more queries which might be subject to a join reduction based on a latent referential integrity relationship, according to the preferred embodiment.

FIG. 6 is a flow diagram showing in greater detail the process of determining whether a query contains a join susceptible to join reduction based on latent referential integrity, according to the preferred embodiment.

### DETAILED DESCRIPTION OF THE PREFERRED EMBODIMENTS

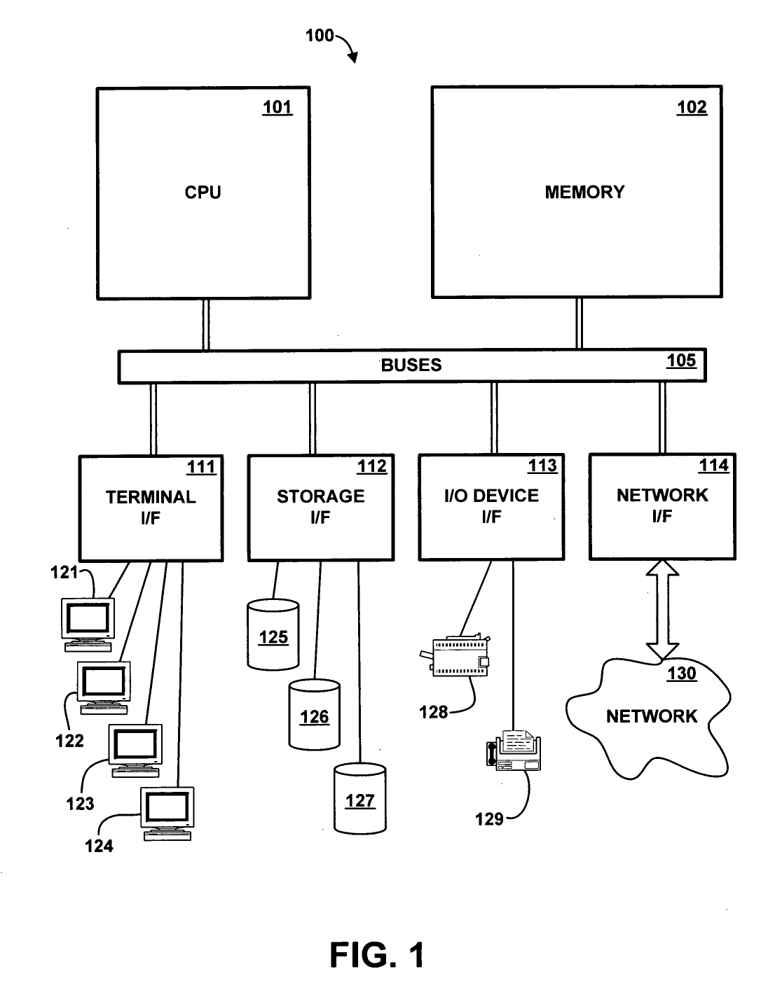

Referring to the Drawing, wherein like numbers denote like parts throughout the several views, FIG. 1 is a high-level representation of the major hardware components of a computer system 100 for use in generating and executing database queries, optimizing query strategies, and detecting a latent referential integrity relationship in a database, according to the preferred embodiment of the present invention. CPU 101 is at least one general-purpose programmable processor which executes instructions and processes data from main memory 102. Main memory 102 is preferably a random access memory using any of various memory technologies, in which data is loaded from storage or otherwise for processing by CPU 101.

One or more communications buses 105 provide a data communication path for transferring data among CPU 101, main memory 102 and various I/O interface units 111-114, which may also be known as I/O processors (IOPs) or I/O adapters (IOAs). The I/O interface units support communication with a variety of storage and I/O devices. For example, terminal interface unit 111 supports the attachment of one or more user terminals 121-124. Storage interface unit 112 supports the attachment of one or more direct access storage devices (DASD) 125-127 (which are typically rotating magnetic disk drive storage devices, although they could alternatively be other devices, including arrays of disk drives configured to appear as a single large storage device to a host). I/O device interface unit 113 supports the attachment of any of various other types of I/O devices, such as printer 128 and fax machine 129, it being understood that other or additional types of I/O devices could be used. Network interface 114 supports a connection to external network 130 for communication with one or more other digital devices. Network 130 may be any of various local or wide area networks known in the art. For example, network 130 may be an Ethernet local area network, or it may be the Internet. Additionally, network interface 114 might support connection to multiple networks.

It should be understood that FIG. 1 is intended to depict the representative major components of system 100 at a high level, that individual components may have greater complexity than represented in FIG. 1, that components other than or in addition to those shown in FIG. 1 may be present, and that the number, type and configuration of such components may vary, and that a large computer system will typically have more components than represented in FIG. 1. Several particular examples of such additional complexity or additional variations are disclosed herein, it being understood that these are by way of example only and are not necessarily the only such variations.

Although only a single CPU 101 is shown for illustrative purposes in FIG. 1, computer system 100 may contain multiple CPUs, as is known in the art. Although main memory 102 is shown in FIG. 1 as a single monolithic entity, memory 102 may in fact be distributed and/or hierarchical, as is known in the art. E.g., memory may exist in multiple levels of caches, and these caches may be further divided by function, so that one cache holds instructions while another holds non-instruction data which is used by the processor or processors. Memory may further be distributed and associated with different CPUs or sets of CPUs, as is known in any of various so-called non-uniform memory access (NUMA) computer architectures. Although communications buses 105 are shown in FIG. 1 as a single entity, in fact communications among various system components is typically accomplished through a complex hierarchy of buses, interfaces, and so forth, in which higher-speed paths are used for communications between CPU 101 and memory 102, and lower speed paths are used for communications with I/O interface units 111-114. Buses 105 may be arranged in any of various forms, such as point-to-point links in hierarchical, star or web configurations, multiple hierarchical buses, parallel and redundant paths, etc. For example, as is known in a NUMA architecture, communications paths are arranged on a nodal basis. Buses may use, e.g., an industry standard PCI bus, or any other appropriate bus technology. While multiple I/O interface units are shown which separate buses 105 from various communications paths running to the various I/O devices, it would alternatively be possible to connect some or all of the I/O devices directly to one or more system buses.

Computer system 100 depicted in FIG. 1 has multiple attached terminals 121-124, such as might be typical of a multi-user “mainframe” computer system. Typically, in such a case the actual number of attached devices is greater than those shown in FIG. 1, although the present invention is not limited to systems of any particular size. User workstations or terminals which access computer system 100 might also be attached to and communicate with system 100 over network 130. Computer system 100 may alternatively be a single-user system, typically containing only a single user display and keyboard input, or a system such as a server containing no directly attached terminals. Furthermore, while the invention herein is described for illustrative purposes as embodied in a single computer system, the present invention could alternatively be implemented using a distributed network of computer systems in communication with one another, in which different functions or steps described herein are performed on different computer systems.

While various system components have been described and shown at a high level, it should be understood that a typical computer system contains many other components not shown, which are not essential to an understanding of the present invention. In the preferred embodiment, computer system 100 is a computer system based on the IBM i/Series™ architecture, it being understood that the present invention could be implemented on other computer systems.

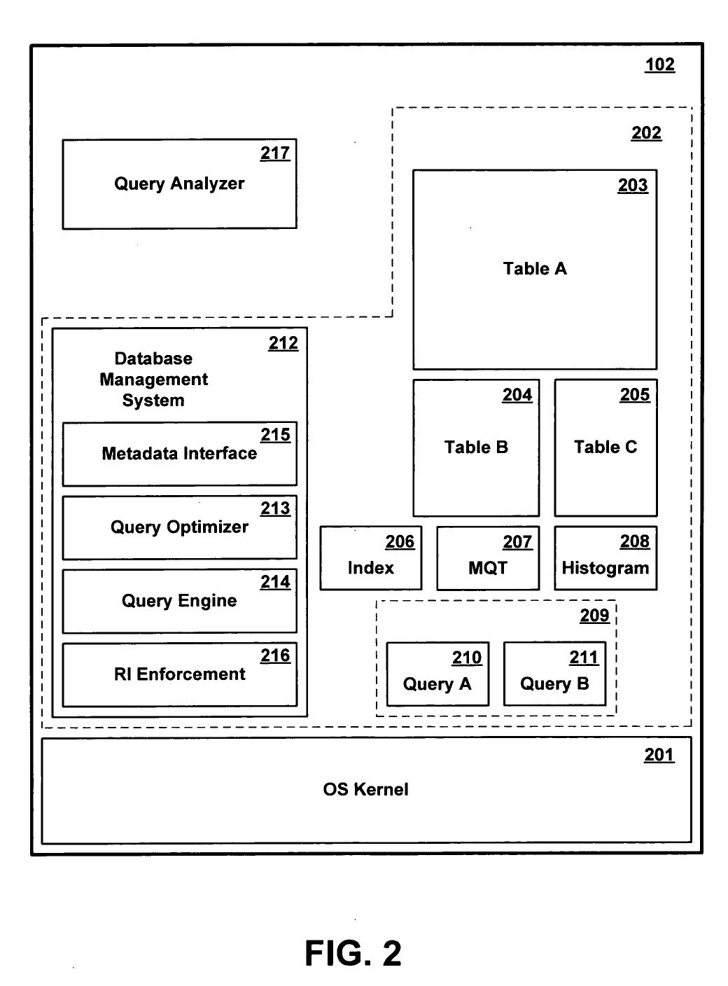

FIG. 2 is a conceptual illustration of the major software components of system 100 in memory 102. Operating system kernel 201 is executable code and state data providing various low-level software functions, such as device interfaces, management of memory pages, management and dispatching of multiple tasks, etc. as is well-known in the art. A structured database 202 contains data which is maintained by computer system 100 and for which the system provides access to one or more users, who may be directly attached to system 100 or may be remote clients who access system 100 through a network using a client/server access protocol.

Database 202 contains one or more tables 203-205 (of which three are shown in FIG. 2), each having a plurality of entries or records, each entry containing at least one (and usually many) fields, as is well known in the art. Database tables 203-205 might contain almost any type of data which is provided to users by a computer system. Associated with the database tables are one or more auxiliary data structures 206-211, also sometimes referred to as metadata. Auxiliary data structures characterize the structure of the database and data therein, and are useful in various tasks involved in database management, particularly in executing queries against the database. Examples of auxiliary data structures include database index 206, materialized query table 207, histogram 208, and plan cache 209 containing saved query objects 210-211, it being understood that other types of metadata may exist.

Database management system 212 provides basic functions for the management of database 202. Database management system 212 may theoretically support an arbitrary number of database tables, which may or may not have related information, although only three tables are shown in FIG. 2. Database management system 212 preferably allows users to perform basic database operations, such as defining a database, altering the definition of the database, creating, editing and removing records in the database, viewing records in the database, defining database indexes, and so forth. Among the functions supported by database management system 212 is the making of queries against data in database tables 203-205, including particularly join queries. Query support functions in database management system 212 include query optimizer 213, query engine 214, and referential integrity (RI) enforcement function 216. In the preferred embodiment, database management system 211 includes a metadata interface 215 having one or more application programming interfaces (APIs) by which external applications can access data in one or more auxiliary data structures 206-211, and particularly can access data in plan cache 209. Database management system 212 may further contain any of various more advanced database functions. Although database management system 212 is represented in FIG. 2 as an entity separate from operating system kernel 201, it will be understood that in some computer architectures various database management functions are integrated with the operating system.

Query optimizer 213 generates query execution strategies for performing database queries. As is known in the database art, the amount of time or resource required to perform a complex query on a large database can vary greatly, depending on various factors, such as the availability of an index or other auxiliary data structure, the amount of resources required to evaluate each condition, and the expected selectivity (i.e., number of records eliminated from consideration) of the various logical conditions. Optimizer 213 determines an optimal execution strategy according to any optimizing algorithm, now known or hereafter developed, and generates an execution strategy, also known as an “access plan” or “plan”, according to the determination. The execution strategy is a defined series of steps for performing the query, and thus is, in effect, a computer program. The optimizer 213 which generates the execution strategy performs a function analogous to that of a compiler, although the execution strategy data is not necessarily executable-level code. It is, rather, a higher-level series of statements which are interpreted and executed by query engine 214.

A query can be saved as a persistent storage object 210-211 in memory, and can be written to disk or other storage. Once created by optimizer 213, a query execution strategy can be saved with the query as part of the persistent storage object. The query can be invoked, and a saved query strategy re-used (re-executed), many times. For a given query, it is possible to generate and save one, or optionally multiple, query execution strategies, each optimized for different respective conditions. E.g., where a query contains an imported (“host”) variable in one of its conditions, the value of which is specified at the time the query is executed, different query execution strategies could be used for different values of the imported variable. Different query execution strategies might also be used for different environmental parameters under which the query is to be executed. In addition to saving one or more query execution strategies, certain metadata with respect to each query execution strategy can be saved, such as the conditions for which the strategy was generated and historical data concerning the execution of the strategy.

The collection of saved queries, query execution strategies and associated data is loosely referred to as the “plan cache”. FIG. 2 represents plan cache 209, containing persistent storage objects Query A 210 and Query B 211. Although two query objects are represented for illustrative purposes in FIG. 2, it will be understood that the actual number of such entities may vary, that typically a large computer system contains a much larger number of query objects, that each query object may contain or be associated with zero, one, or more than one execution strategies. Although these are referred to herein as “query objects”, the use of the term “object” is not meant to imply that database management system 212 or other components are necessarily programmed using so-called object-oriented programming techniques, or that the query object necessarily has the attributes of an object in an object-oriented programming environment, although it would be possible to implement them using object-oriented programming constructs.

Although one database 202 having three database tables 203-205, one index 206, one MQT 207 and one histogram 208 are shown in FIG. 2, the number of such entities may vary, and could be much larger. The computer system may contain multiple databases, each database may contain multiple tables, and each database may have associated with it multiple indexes, MQTs, histograms, or other auxiliary data structures not illustrated. Alternatively, some entities represented in FIG. 2 might not be present in all databases; for example, some databases might not contain materialized query tables or the like. Additionally, database 202 may be logically part of a larger distributed database which is stored on multiple computer systems. Although database management system 212 is represented in FIG. 2 as part of database 202, the database management system, being executable code, is sometimes considered an entity separate from the “database”, i.e., the data.

An external query analytical tool application 217 accesses queries in the plan cache 209 using metadata interface 215, and in particular attempts to identify join queries which might be subject to reduction based on a probable latent referential integrity relationship. The operation of this analytical tool is described in greater detail herein. In the preferred embodiment, query analyzer 217 is a separate application external to database management system 211, although it could alternatively be a function or set of functions integrated into database management system 211.

In addition to database management system 212 and analytical tool 217, one or more user applications (not shown) may access data in database tables 203-205 to perform tasks on behalf of one or more users. Such user applications may execute on computer system 100, or may access the database from remote systems. Such user applications may include, e.g., personnel records, accounting, code development and compilation, mail, calendaring, or any of thousands of user applications.

Various software entities are represented in FIG. 2 as being separate entities or contained within other entities. However, it will be understood that this representation is for illustrative purposes only, and that particular modules or data entities could be separate entities, or part of a common module or package of modules. Furthermore, although a certain number and type of software entities are shown in the conceptual representation of FIG. 2, it will be understood that the actual number of such entities may vary, and in particular, that in a complex database server environment, the number and complexity of such entities is typically much larger. Additionally, although software components 202-217 are depicted in FIG. 2 on a single computer system 100 for completeness of the representation, it is not necessarily true that all programs, functions and data will be present on a single computer system or will be performed on a single computer system. For example, query analyzer 217 may be on a separate system from the database; a database may be distributed among multiple computer systems, so that queries against the database are transmitted to remote systems for resolution, and so forth.

While the software components of FIG. 2 are shown conceptually as residing in memory 102, it will be understood that in general the memory of a computer system will be too small to hold all programs and data simultaneously, and that information is typically stored in data storage devices 125-127, comprising one or more mass storage devices such as rotating magnetic disk drives, and that the information is paged into memory by the operating system as required. In particular, database tables 203-205 are typically much too large to be loaded into memory, and typically only a small portion of the total number of database records is loaded into memory at any one time. The full database 202 is typically recorded in disk storage 125-127. Furthermore, it will be understood that the conceptual representation of FIG. 2 is not meant to imply any particular memory organizational model, and that system 100 might employ a single address space virtual memory, or might employ multiple virtual address spaces which overlap.

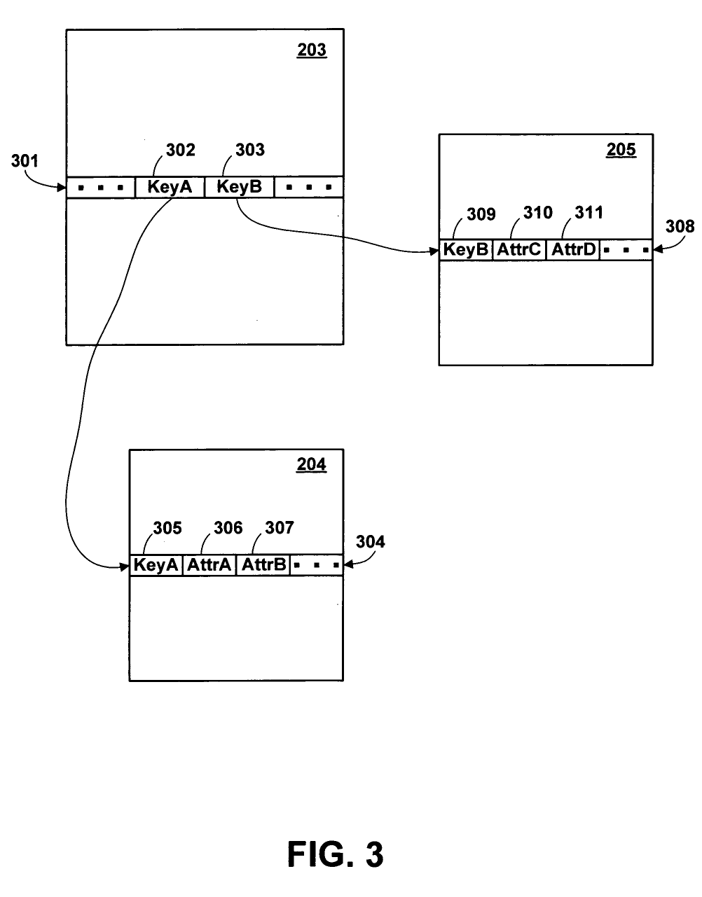

FIG. 3 is a conceptual representation of a simplified database environment in which keys are used to create associations of records in different tables, i.e., a key in a first table is used to reference an entry in a second table, according to the preferred embodiment. Referring to FIG. 3, table 203 contains a plurality of entries 301, each entry including one or more foreign key fields 302, 303 (of which two are illustrated in FIG. 3, it being understood that the number could vary). Each foreign key refers to a key column in another table. As represented in FIG. 3, foreign key 302 is an index to an entry 304 in table 204; foreign key 303 is an index to an entry 308 in table 205. Each entry 304 in table 204 contains a respective primary key field 305 (to which foreign key 302 refers) and one or more attribute fields 306, 307 (of which two are shown in FIG. 3, it being understood that the number could vary). Each entry 308 in dimension table 205 similarly contains a respective primary key field 309 (to which foreign key 303 refers) and one or more attribute fields 310, 311. Entries 304 or 308 in dimension tables 204 or 205 may optionally themselves contain one or more foreign key fields which reference entries in additional tables (not shown), forming a hierarchy or network of references in multiple tables.

In many instances in which one key in one table is matched to another key in another table, it is desirable to maintain referential integrity (RI). The purpose of putting foreign keys 302, 303 in entries 301 of table 203 is to reference entries in one or more other tables, and therefore the values stored in these keys should in fact be represented in the table being referenced. I.e., except for a specially defined value meaning ‘no reference’ (herein referred to as “null”, although it could be some other specially defined value), there should not be values in the foreign key fields which do not correspond to anything in the referenced tables. Furthermore, since each foreign key is intended to reference a specific record in another table, the values of the primary keys 305, 309 should be unique in the referenced tables (or else a foreign key might reference multiple records in the referenced table). The constraints that (a) each value of primary key 305 is unique in table 204 and non-null, and (b) each non-null value of foreign key 302 in table 203 appears in primary key 305 in table 204, define a referential integrity relationship.

Where the database designer has explicitly specified the existence of a referential integrity relationship, database management system 211 enforces the referential integrity constraints, so that no records in the database violate the constraints. The RI enforcement mechanism 216 will typically check every database update to assure that it complies with the constraints. For example, if referential integrity is specified in the relationship depicted in FIG. 3 between tables 203 and 204, the enforcement mechanism (a) would check any new record added to table 203 or altered record in which foreign key field 302 has changed to assure that the value of foreign key field 302 in the record is either null or the same as a value in field 305 of table 204; (b) would check any record deleted from table 204 or altered record in which primary key field 305 has changed to assure that the value of primary key field 305 in the deleted record or the old value of primary key field 305 in the altered record is not found in any foreign key field 302 of table 203; and (c) would check any record added to table 204 or altered record in which primary key field 305 has changed to assure that the new value of primary key field 305 is unique (not duplicated) in the primary key fields 305 of table 204. The RI enforcement mechanism 216 may further contain a function for verifying referential integrity in existing data. I.e., if a referential integrity relationship is specified for an existing database, the enforcement mechanism would scan the applicable existing tables to verify that the specified referential integrity constraints are met. Thereafter it would, of course, verify compliance with referential integrity in any updates to the data.

However, there are often cases in which the data in the database adheres to the constraints of a referential integrity relationship, but the database designer has not defined such a relationship. Such a situation is referred to herein as a latent referential integrity relationship. In such a case, enforcement mechanism 216 does not enforce referential integrity, and from the perspective of database management system 212, it is theoretically possible to add or modify a record such that a referential integrity constraint would be not be met. A latent referential integrity relationship may arise because the database designer simply forgot to specify referential integrity when the database was originally defined. It may also be the result of a deliberate decision on the part of the designer to avoid the database's internal referential integrity enforcement mechanism 216 and use some external mechanism to enforce referential integrity when modifying the database.

Where latent referential integrity exists, conventional optimizers will be unable to perform certain optimizations, particularly reduction of a join operation, because the optimizer is unable to rely on the existence of a referential integrity relationship. In accordance with the preferred embodiment of the present invention, a probable latent referential integrity relationship is automatically detected, and the user prompted to choose an appropriate course of action with respect to optimization of a join operation. In a first preferred embodiment, detection is performed as part of an analyzer application 217 separate from database management system, which reviews queries in plan cache 209 for possible optimization candidates based on a latent referential integrity relationship. In an alternative embodiment, detection is performed when a query is required to be optimized. These embodiments are further explained below and illustrated in the following flow diagrams.

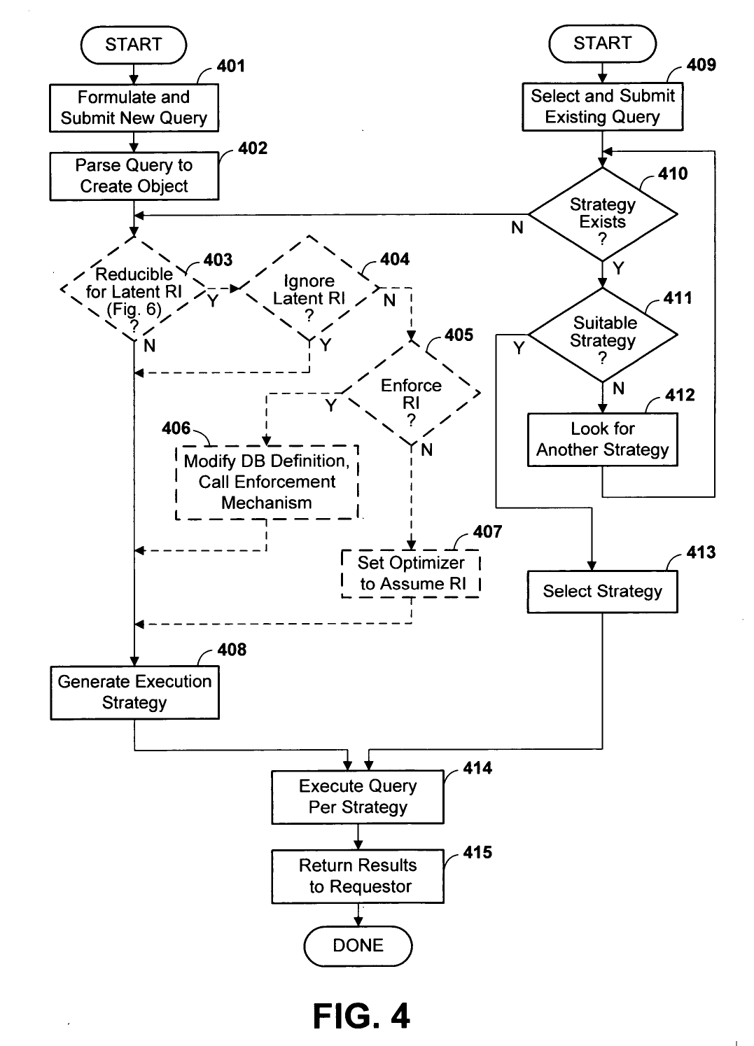

FIG. 4 is a flow diagram illustrating at a high level the process of executing a database query, according to the preferred embodiment. Referring to FIG. 4, a query may be initiated either as a newly defined query, or as a re-used (previously executed and saved) query, as shown by the two paths beginning at blocks 401 and 409, respectively.

For a new query, a requesting user formulates and submits a database query using any of various techniques now known or hereafter developed (step 401). E.g., the database query might be constructed and submitted interactively using a query interface in database management system 212, might be submitted from a separate interactive query application program, or might be embedded in a user application and submitted by a call to the query engine 214 when the user application is executed. A query might be submitted from an application executing on system 100, or might be submitted from a remote application executing on a different computer system. In response to receiving the query, query engine 214 parses the query into logical conditions to generate a query object (step 402), which may be saved for re-use.

In an optional alternative embodiment, represented as steps 403-407, database management system 212 analyzes the query to detect whether it is a join query subject to reduction based on probable latent referential integrity, and if so takes appropriate action as directed by the user. Where this optional alternative is not implemented, steps 403-407 are by-passed, and the optimizer 213 is called to generate an appropriate query execution strategy (step 408). Optimizer 213 generates an optimized execution strategy using any appropriate technique, now known or hereafter developed. In particular, it is preferred that the optimizer have the capability to reduce a join within a query based on the existence of an explicitly defined referential integrity relationship, as is known in the art. In addition, the optimizer can reduce a join within the query based on a user direction to assume the existence of a referential integrity relationship, even where one has not been explicitly defined and enforced in the database. The generated execution strategy is preferably saved in the query object 210. After generation and saving of a suitable execution strategy at steps 408, the database management system proceeds to step 414.

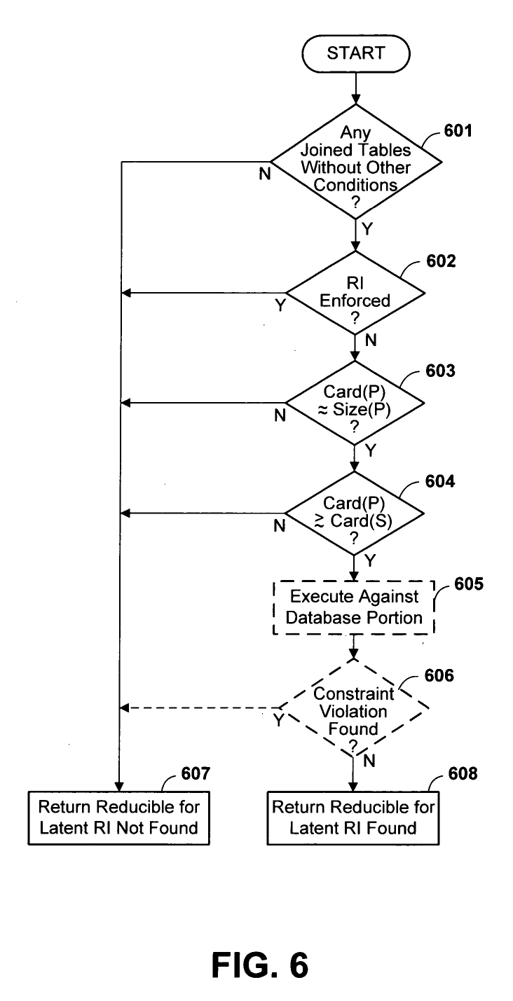

In the optional embodiment shown in steps 403-408, a function in the database management system is called to determine whether a join would be reducible if a referential integrity relationship existed, and whether a probable latent referential integrity relationship exists. This step is represented in FIG. 4 as block 403, and is described and shown in further detail below with respect to FIG. 6. If a probable latent referential integrity relationship is detected which might result in a join reduction (the ‘Y’ branch from block 403), the user is prompted for an appropriate action. In general, the user can do one of three things: (a) the user can direct the optimizer to ignore the probable latent referential integrity (represented as the ‘Y’ branch from step 404); (b) the user can alter the database definition to explicitly enforce referential integrity (the ‘Y’ branch from step 405); or (c) the user can instruct the optimizer to construct an optimized query as if referential integrity exists, without enforcing referential integrity (the ‘N’ branch from step 405).

If the user directs the optimizer to ignore the probable latent referential integrity, the ‘Y’ branch is taken from step 404, and the optimizer proceeds to construct an optimized query execution strategy at step 408 as if the determination at step 403 had not been made (i.e., the join will not be reduced). It is necessary to give the user the option to elect this path because, as explained further herein, a determination of probable latent referential integrity is based on heuristics, and it fact it is possible that no such latent referential integrity exists (in which case reduction of the join could produce incorrect query results). However, even if latent referential integrity does exist, the user may still wish to avoid join reduction for reasons of assuring future data integrity or other considerations.

If the user chooses to alter the database definition to enforce referential integrity, the ‘Y’ branch is taken from step 405, and the database definition is modified so that a referential integrity relationship is explicitly specified for the corresponding probable latent referential integrity relationship (step 406). The explicitly defined referential integrity will cause RI enforcement mechanism 216 to verify that any future modifications to the database conform to the explicitly defined referential integrity constraints. Additionally, the RI enforcement mechanism is preferably called to verify that all records currently in the applicable database tables conform to the referential integrity constraints. The optimizer then generates an execution strategy (step 408). In this case, because referential integrity has been explicitly defined and enforced, the optimizer is able to reduce the join query

If the user chooses not to enforce referential integrity but to construct an optimized query as if referential integrity exists, the ‘N’ branch is taken from step 405, and the optimizer input options are set so that the optimizer will assume the existence of a referential integrity relationship, even though one is not explicitly defined (step 407). The optimizer is then invoked to generate an execution strategy (step 408). As a result of the assumed referential integrity relationship, the optimizer will be able to reduce the join in the query in the same manner as if referential integrity had been explicitly defined.

Although the user is given the option to explicitly enforce referential integrity at step 405, it will be observed that this procedure could take some time, and is typically more time-consuming than simply executing the original query in a non-reduced form. Therefore the path represented by step 406 would typically not be taken at this stage. It is normally expected that the user would simply optimize as if referential integrity exists (the path through step 407), and, if the user so desires, modify the database definition to explicitly enforce referential integrity as a separate, asynchronous task (not shown). As a further alternative embodiment, the option shown as the path through step 406 need not be offered to the user for this reason.

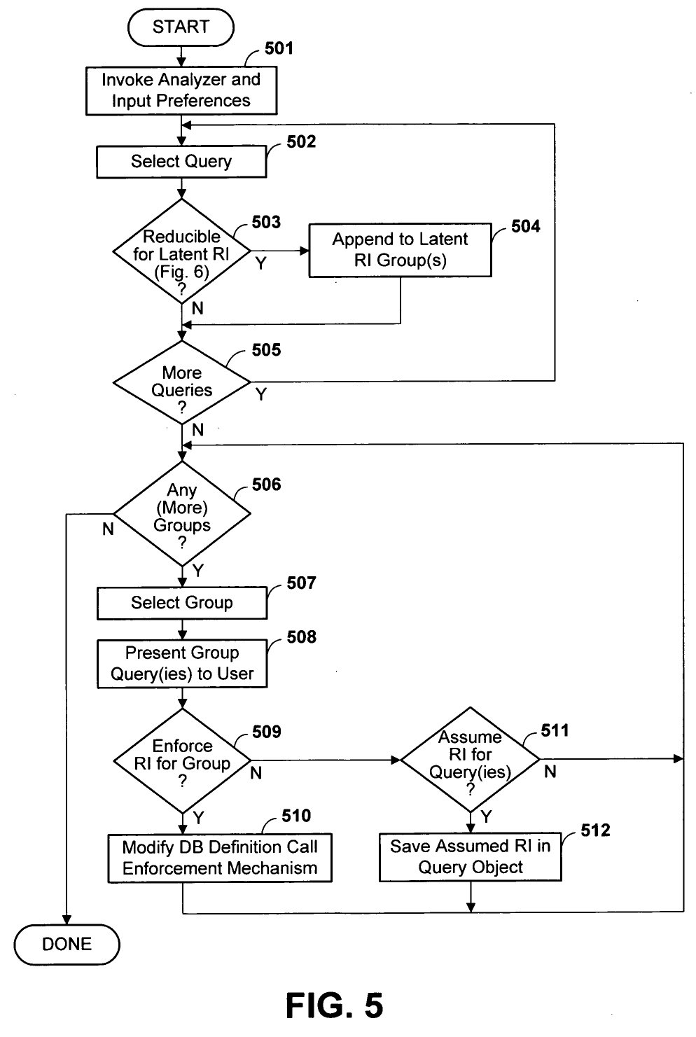

As a further alternative embodiment (not shown), the optimizer could make the determination represented by step 403, but simply save this data for later presentation to the user and later action on the part of the user. In this further alternative embodiment, data from multiple query optimizations could be aggregated and presented to the user at the user's request, offering the user those same options which are discussed below with respect to FIG. 5.

Where an existing query is re-used, a requesting user selects the existing query object for re-use and invokes it, using any of various techniques now known or hereafter developed (step 409). E.g., the query might be selected interactively from a menu in database management system 212, might be submitted from a separate interactive application program, or might be embedded in a user application and submitted by a call to the query engine 214 when the user application is executed, any of which might be performed from system 100, or from a remote system.

In response to invoking the query, query optimizer 213 determines whether a saved strategy exists in the query object 209 (step 410). If no such strategy exists (the ‘N’ branch from step 410), the optimizer generates one (steps 403-408), as in the case of a new query.

If a previously saved execution strategy exists for the query (the ‘Y’ branch from step 410), the optimizer determines whether the saved execution strategy is suitable for use under the conditions of the current query instance, e.g., current imported variable values, environmental parameters, and so forth (step 411). This determination may be made using any appropriate technique, now known or hereafter developed. In the case of a strategy in which a join was reduced based on an assumed referential integrity relationship (using the path through step 407), the optimizer will not necessarily verify the existence of referential integrity. The optimizer could prompt the user to verify referential integrity, or could simply proceed on the assumption that referential integrity exists. If the saved execution strategy is not suitable for use in the current query instance, then the ‘N’ branch is taken from step 411, and the database management system looks for another previously saved execution strategy (step 412), continuing then to step 410. The database management system continues to look for execution strategies (loop at steps 410-412) until a suitable strategy is found (the ‘Y’ branch from step 411) or there are no more strategies (the ‘N’ branch from step 410).

If a suitable execution strategy is found, the ‘Y’ branch is taken from step 411, and the execution strategy is selected (step 413). Where multiple execution strategies are permissible (multiple strategies satisfy their respective logical conditions), the database manager will choose one of these multiple strategies. Such a choice could be based on priorities, or any criteria or technique now known or hereafter developed, or could be arbitrary. After selecting a strategy, the database management system proceeds to step 414.

The query engine is then invoked to execute the query according to the query execution strategy which was either generated at step 408 or selected at step 413 (step 414). Generally, this means that the query engine retrieves selective database records according to the query execution strategy, and evaluates the logical query conditions with respect to the selected record in an order determined by the strategy, using any known technique or technique hereafter developed. E.g., for a conjunction of logical ANDs, each successive condition is evaluated until a condition returns “false” (which obviates the need to evaluate any further conditions) or until all conditions are evaluated.

The query engine then generates and returns results in an appropriate form (step 415). E.g., where a user issues an interactive query, this typically means returning a list of matching database entries for display to the user. A query from an application program may perform some other function with respect to database entries matching a query.

FIG. 5 is a flow diagram showing the process of analyzing multiple queries in the plan cache to find one or more queries which might be subject to a join reduction based on a latent referential integrity relationship, according to the preferred embodiment. In this embodiment, the query analyzer 217 analyzes one or more queries stored in plan cache 209 to find queries potentially subject to join reduction based on probable latent referential integrity. This analysis is preferably performed independently of executing any query instance, i.e., it is performed for the intention of improving performance of an indefinite number of future query instance executions, and not for optimizing some particular immediate instance of a query. It can be, although it need not be, performed at a scheduled time when system utilization is normally low.

Referring to FIG. 5, a user invokes the query analyzer 217 and inputs any required user preferences for performing an analysis of queries containing joins which are potentially subject to reduction (step 501). User preferences might include, for example, any or all of: a subset of logical queries to be analyzed (which could amount to a single query, or could be all the queries); an action to be taken with respect to queries subject to potential join, or other options governing the scope or conduct of the analysis.

The analyzer selects a query (a query object 210) to be analyzed from plan cache 209 (step 502). It then determines whether a join would be reducible if a referential integrity relationship existed, and whether a probable latent referential integrity relationship exists. This step is represented in FIG. 5 as block 503. It is the same determination as that made in optional step 403, and is described and shown in further detail below with respect to FIG. 6. However, in the preferred embodiment this determination is performed by analyzer 217. If a probable latent referential integrity relationship is detected which might result in a join reduction (the ‘Y’ branch from block 503), the query is appended to one or more latent referential integrity groups (step 504), one or more new latent RI groups being created where necessary. Each latent RI group corresponds to a respective latent referential integrity relationship, i.e. a pair of database tables, one containing a potential primary key and the other a potential foreign key. The latent RI group contains all queries containing joins which might be reducible if a referential integrity relationship of the corresponding table pair could be assured or assumed. It is possible that a single query will contain multiple joins subject to reduction based on multiple respective latent referential integrity relationships, and in this case the query would be appended to multiple respective latent RI groups.

If there are any more queries in the plan cache to analyze, the ‘Y’ branch is taken from step 505 to step 502, and a next query is selected for analysis. When all queries have been thus analyzed, the ‘N’ branch is taken from step 505.

If any latent RI groups have been created at step 504, the ‘Y’ branch is taken from step 506, and a latent RI group is selected at step 507. The analyzer then presents data with respect to the group to the user (step 508). In the preferred embodiment, “presenting” to the user means that certain data with respect to the latent RI group is displayed to the user on an interactive display screen, and the user is allowed to make certain choices with respect to the displayed data. However, “presenting” data to the user could take any of various other forms, such as outputting data to a printing device, transmitting data to a remote digital device, saving data in electronic form in a file for later retrieval by a user, etc. The data being presented could vary, but preferably includes an identification of the latent referential integrity relationship to which the group corresponds, e.g., by identifying the database tables and keys. The data also preferably includes an identification of the queries which are part of the latent RI group, i.e., the queries potentially subject to join reduction if actual referential integrity can be enforced or assumed. Data presented on an interactive display could be arranged according to any conventional method, including hierarchical arrangements in which more detailed data with respect to some displayed object can be obtained by selecting the object. For example, a list of queries in the latent RI group might be displayed in abbreviated form, and selection of any query in the list might display detailed information with respect to the selected query. An interactive display of latent RI group data may include additional data, such as historical performance data of queries in the group, projected future performance if join reduction is applied, and so forth.

With respect to a latent RI group presented to the user, the user has basically the same three options as explained with respect to optional steps 404-407 described above. I.e., the user may (a) ignore the latent RI and do nothing (represented as the ‘N’ branch from step 511); (b) alter the database definition to explicitly enforce referential integrity (the ‘Y’ branch from step 509); or (c) assume referential integrity for purposes of one or more queries in the group, allowing the optimizer reduce the join operation as if referential integrity exists, without enforcing referential integrity (the ‘Y’ branch from step 512).

If the user chooses to alter the database definition to enforce referential integrity, the ‘Y’ branch is taken from step 509, and the database definition is modified so that a referential integrity relationship is explicitly specified for the corresponding latent referential integrity relationship (step 510). The explicitly defined referential integrity will cause RI enforcement mechanism 216 to verify that any future modifications to the database conform to the explicitly defined referential integrity constraints. The RI enforcement mechanism is further called to verify that all records currently in the applicable database tables conform to the referential integrity constraints. As a result of an enforced referential integrity relationship, the optimizer will be able to perform a join reduction in any future execution strategies constructed by it for any query in the latent RI group. This will not necessarily affect the existing saved execution strategies, which might continue to be used. As an additional step (not shown), the analyzer could optionally automatically delete these existing saved strategies or otherwise force re-optimization. Alternatively, the deletion of existing strategies could be left to the user. The analyzer then returns to step 506 to select a next group.

If the user chooses not to enforce referential integrity but to assume referential integrity for purposes of one or more queries, the ‘Y’ branch is taken from step 511, and the analyzer saves the assumed referential integrity status in one or more query objects (step 512). Generally, the user will assume referential integrity for all queries in the latent RI group, but the user may optionally elect to assume referential integrity for only some user-selected subset of queries in the group. The assumed referential integrity status is saved in the query object of any query for which RI is to be assumed, and this has the effect of causing the optimizer to subsequently generate any execution strategies as if referential integrity exists, i.e., to reduce the join in the same manner as if referential integrity had been explicitly defined. As in the case of explicitly enforced referential integrity, assumed referential integrity will not necessarily affect the existing saved execution strategies, which might continue to be used. The analyzer could optionally automatically delete these existing saved strategies, or leave deletion to the user. The analyzer then returns to step 506 to select a next group.

If the user elects to ignore the probable latent referential integrity relationship, the ‘N’ branch is taken from step 511, and a next group is selected for presentation. When all groups have been presented to the user and user actions obtained, the analyzer 217 has finished its task.

FIG. 6 is a flow diagram showing in greater detail the process of determining whether a query contains a join susceptible to join reduction based on a probable latent referential integrity relationship, which is shown at a high level in FIG. 4 as step 403 and in FIG. 5 as step 504. The query is parsed to determine whether it contains any joined tables without other conditions (step 601). I.e., if the query contains a join of a table P to a table S, and the query contains no conditions on the records from table P other than the join itself, then the condition expressed in step 601 is met, and the ‘Y’ branch is taken. If there is no such join in the query, the ‘N’ branch is taken from step 601, and the process of FIG. 6 returns no reducible query found (step 607). A query could contain multiple such joins, in which case the analysis which follows is performed separately for each such join. For clarity of illustration and description, only one path of analysis is shown.

If a referential integrity relationship has already been defined for table P (as primary or containing the primary key) and S (as secondary or containing the foreign key), then the ‘Y’ branch is taken from step 602, and the process returns no reducible query found (step 607). In this case, there is no need for further analysis because referential integrity has already been defined in the database, and the optimizer will use that fact to reduce the join without any further action on the part of the analyzer or the user. If referential integrity has not already been defined, the ‘N’ branch is taken from step 602 and the analysis continues.

The cardinality of the key used in the join of table P (i.e., the assumed primary key) is compared to the size of table P (step 603), and the ‘N’ branch taken to step 607 if the two are not substantially equal. This comparison is performed in order to verify that values of the assumed primary key are unique. Many databases will contain some measure of the cardinality (i.e., the number of different values) of various fields of various tables. These measures are useful in optimizing queries and for other purposes. Where such a measure does not exist, it would be possible to construct it by sampling, as is known in the art. Typically, these measures are estimates based on some form of sampling, rather than exact counts of number of different values. If latent referential integrity exists, then the assumed primary key should be unique, and its cardinality should be equal to the number of records in table P. Because cardinality is typically only an estimate, some deviation in the two values is tolerable. However, a large difference indicates that the assumed primary key is not unique, and therefore latent referential integrity does not exist. If the two values are substantially the same, the ‘Y’ branch is taken from step 603.

The cardinality of the assumed primary key is compared to the cardinality of the assumed foreign key in table S (step 604), and the ‘N’ branch taken to step 607 if the cardinality of the assumed primary key is substantially less than the cardinality of the assumed foreign key. This comparison is performed in order to verify that each value of a foreign key is found in the primary key. If the cardinality of the primary key is significantly less than that of the foreign key, this requirement is not met, and latent referential integrity does not exist. As in the case of the previous comparison, since cardinalities are only estimates, some deviation is tolerable. If the two values are substantially the same, or the cardinality of the primary key is greater, then the ‘Y’ branch is taken from step 604.

After performing the analysis indicated by steps 601-604, and taking the ‘Y’ branch from step 604, it is optionally possible to further execute the join condition against some portion of the data in the tables to see whether referential integrity constraints are satisfied (represented as optional steps 605 and 606). Specifically, a simplified query consisting only of the join is executed against some portion of data in table S by attempting to find, for each record in S, a corresponding unique key value in table P (step 605). If a record is found in table S, for which there is no primary key value in P corresponding to foreign key value of S, or for which there is more than one such primary key value in P, then referential integrity constraints are violated, and the ‘Y’ branch is taken from step 606 to step 607. If no such record is found, then the ‘N’ branch is taken from step 606. Typically, the number of records of table S which are reviewed in step 605 is a relatively small sample compared to the size of table S, but sufficiently large to give some confidence in the result. However, the number of records reviewed could vary depending on the degree of confidence desired, and could include all the records of table S.

If optional steps 605-606 are by-passed, or if the ‘N’ branch is taken from step 606, the process returns the reducible join based on a probable latent referential integrity relationship (step 608).

Among the advantages of the technique described herein as a preferred embodiment is the relatively low overhead of implementation and maintenance in that it generally uses information which is already available and maintained by the database for other purposes. I.e., the plan cache already exists for purposes of re-using query strategies and facilitating the construction of new strategies, measures of cardinality of database fields exist in most databases, etc. The technique described herein uses this readily available data to identify queries which might be subject to join reduction, and allows the user to take appropriate action to obtain the benefits of join reduction in future query executions. This information would be difficult for the user to obtain by conventional means.

In the preferred embodiment described above, the generation and execution of the query, and the analysis of query data, is described as a series of steps in a particular order. However, it will be recognized by those skilled in the art that the order of performing certain steps may vary, and that variations in addition to those specifically mentioned above exist in the way particular steps might be performed. In particular, the manner in which queries are written, parsed or compiled, and stored, may vary depending on the database environment and other factors.

In the preferred embodiment, an analytical tool or function both identifies joins which might be susceptible to join reduction and probable latent referential integrity relationships. However, an analytical tool might perform either of these functions individually, and present results to the user. For example, a tool might identify join queries which could be reduced if referential integrity were known, without attempting to identify latent referential integrity, and present these results to the user. The user might, in these cases, know that latent referential integrity does exist. Similarly, the tool might identify latent referential integrity relationships without attempting to identify join queries subject to reduction. Such a function might be useful in identifying relationships for which referential integrity should be enforced, and thereby facilitate optimization of future queries, including queries not yet written.

In general, the routines executed to implement the illustrated embodiments of the invention, whether implemented as part of an operating system or a specific application, program, object, module or sequence of instructions, are referred to herein as “programs” or “computer programs”. The programs typically comprise instructions which, when read and executed by one or more processors in the devices or systems in a computer system consistent with the invention, cause those devices or systems to perform the steps necessary to execute steps or generate elements embodying the various aspects of the present invention. Moreover, while the invention has and hereinafter will be described in the context of fully functioning computer systems, the various embodiments of the invention are capable of being distributed as a program product in a variety of forms, and the invention applies equally regardless of the particular type of signal-bearing media used to actually carry out the distribution. Examples of signal-bearing media include, but are not limited to, volatile and non-volatile memory devices, floppy disks, hard-disk drives, CD-ROM's, DVD's, magnetic tape, and so forth. Furthermore, the invention applies to any form of signal-bearing media regardless of whether data is exchanged from one form of signal-bearing media to another over a transmission network, including a wireless network. Examples of signal-bearing media are illustrated in FIG. 1 as system memory 102, and as data storage devices 125-127.

Although a specific embodiment of the invention has been disclosed along with certain alternatives, it will be recognized by those skilled in the art that additional variations in form and detail may be made within the scope of the following claims:

What is claimed is:

1. A method for analyzing a database, comprising the computer-executed steps of:
identifying a probable latent referential integrity relationship between a first field of a first table of said database and a second field of a second table of said database, said first field being a primary key of said latent referential integrity relationship and said second field being a foreign key of said latent referential integrity relationship, wherein said database contains no explicitly defined referential integrity relationship between said first field and said second field, said identifying step using at least one heuristic; and
presenting results of said identifying step to a user.

2. The method for analyzing a database of claim 1, further comprising the computer-executed step of:
identifying at least one query containing a join condition joining said first field of said first table and said second field of said second table, each said at least one query containing no further conditions on records of said first table.

3. The method for analyzing a database of claim 2, wherein said step of identifying at least one query containing a join condition and said step of identifying a probable latent referential integrity relationship are performed as part of constructing a query execution strategy for said at least one query.

4. The method for analyzing a database of claim 2, wherein said step of identifying at least one query containing a join condition and said step of identifying a probable latent referential integrity relationship are performed by an analytical function which reviews a plurality of previously stored queries to identify said at least one query containing a join condition, and responsive to identifying said at least one query containing a join condition, determines whether said probable latent referential integrity relationship exists.

5. The method for analyzing a database of claim 1, wherein said at least one heuristic comprises at least one of the set consisting of: (a) a comparison of an estimated cardinality of said first field in said first table with a number of records in said first table; (b) a comparison of an estimated cardinality of said first field in said first table with an estimated cardinality of said second field in said second table; and (c) a comparison of values of said second field from a sampled subset of records of said second table with corresponding values of said first field of said first table, said sampled subset of records being fewer than all the records of said second table.

6. The method for analyzing a database of claim 1, further comprising the computer-executed steps of:
responsive to said step of presenting results to a user, receiving a user selection to define an explicit referential integrity relationship between said first field and said second field; and
responsive to receiving said user selection, automatically defining an explicit referential integrity relationship between said first field and said second field, and automatically verifying that the records of said first field and said second field conform to said explicit referential integrity relationship.

7. The method for analyzing a database of claim 1, further comprising the computer-executed steps of:
responsive to said step of presenting results to a user, receiving a user selection to assume the existence of a referential integrity relationship between said first field and said second field for purposes of optimizing at least one query against said database; and
responsive to receiving said user selection, automatically optimizing at least one query against said database using an assumed referential integrity relationship between said first field and said second field.

8. A computer program product for analyzing a database, comprising:
a plurality of computer-executable instructions recorded on signal-bearing media, wherein said instructions, when executed by at least one computer system, cause the at least one computer system to perform the steps of:
identifying at least one query against data in said database, said at least one query containing a join condition joining a first field of a first table of said database and a second field of a second table of said database, said query containing no further conditions on records of said first table, wherein said database contains no explicitly defined referential integrity relationship between said first field and said second field; and
presenting results of said identifying step to a user.

9. The computer program product of claim 8, wherein said instructions, when executed by the at least one computer system, further cause the at least one computer system to perform the step of:
identifying a probable latent referential integrity relationship between said first field of said first table and said second field of said second table, said first field being a primary key of said latent referential integrity relationship and said second field being a foreign key of said latent referential integrity relationship.

10. The computer program product of claim 9, wherein said step of identifying a probable latent referential integrity relationship identifies the probable latent referential integrity relationship using at least one heuristic.

11. The computer program product of claim 9, wherein said instructions cause said computer system to perform said step of identifying at least one query against data in said database and said step of identifying a probable latent referential integrity relationship by reviewing a plurality of previously stored queries to identify said at least one query against data in said database, and responsive to identifying said at least one query, determining whether said probable latent referential integrity relationship exists.

12. The computer program product of claim 8, wherein said instructions further cause the at least one computer system to perform the steps of:
responsive to said step of presenting results to a user, receiving a user selection to define an explicit referential integrity relationship between said first field and said second field; and
responsive to receiving said user selection, automatically defining an explicit referential integrity relationship between said first field and said second field, and automatically verifying that the records of said first field and said second field conform to said explicit referential integrity relationship.

13. The computer program product of claim 8, wherein said instructions further cause the at least one computer system to perform the steps of:
responsive to said step of presenting results to a user, receiving a user selection to assume the existence of a referential integrity relationship between said first field and said second field for purposes of optimizing at least one said query identified by said identifying step; and
responsive to receiving said user selection, automatically optimizing the at least one said query identified by said identifying step using an assumed referential integrity relationship between said first field and said second field.

14. A computer system, comprising:
at least one processor;
a data storage for storing a database, said database containing a plurality of database tables;
a database management facility embodied as a plurality of instructions executable on said at least one processor, said database management facility executing logical queries against data in said database, aid logical queries including join queries joining data from different tables of said database;
an analyzer function embodied as a plurality of instructions executable on said at least processor, said analyzer function identifying a probable latent referential integrity relationship between a first field of a first table of said database and a second field of a second table of said database for presentation to a user, said first field being a primary key of said latent referential integrity relationship and said second field being a foreign key of said latent referential integrity relationship, wherein said database contains no explicitly defined referential integrity relationship between said first field and said second field, said analyzer using at least one heuristic to identify said probably latent referential integrity relationship.

15. The computer system of claim 14,
wherein at least some of said logical queries executed by said database management facility include join queries joining data from different tables of said database; and
wherein said analyzer function further identifies at least one query containing a join condition joining said first field of said first table and said second field of said second table, each said at least one query containing no further conditions on records of said first table.

16. The computer system of claim 15, wherein said analyzer function identifies said at least one query containing a join condition and said probable latent referential integrity relationship as part of constructing a query execution strategy for said at least one query.

17. The computer system of claim 14, wherein said analyzer function is separate from said database management system.

18. The computer system of claim 14, wherein said at least one heuristic comprises at least one of the set consisting of: (a) a comparison of an estimated cardinality of said first field in said first table with a number of records in said first table; (b) a comparison of an estimated cardinality of said first field in said first table with an estimated cardinality of said second field in said second table; and (c) a comparison of values of said second field from a sampled subset of records of said second table with corresponding values of said first field of said first table, said sampled subset of records being fewer than all the records of said second table.

19. The computer system of claim 14,
wherein said analyzer presents a user with a selection to automatically define an explicit referential integrity relationship between said first field and said second field; and
responsive to a user selection to define an explicit referential integrity relationship between said first field and said second field, said database management facility automatically defines an explicit referential integrity relationship between said first field and said second field, and automatically verifies that the records of said first field and said second field conform to said explicit referential integrity relationship.

20. The computer system of claim 14,
wherein said analyzer presents a user with a selection to assume the existence of a referential integrity relationship between said first field and said second field for purposes of optimizing at least one query against said database; and
responsive to a user selection to assume the existence of a referential integrity relationship between said first field and said second field for purposes, said database management facility automatically optimizes at least one query against said database using an assumed referential integrity relationship between said first field and said second field.
